(19) United States
(12) Patent Application Publication
(10) Pub. No.: US 2007/0260477 A1
(43) Pub. Date: Nov. 8, 2007

(54) Method for manufacturing a solid uniform flood source for quality control of gamma imaging cameras

(75) Inventor: Keith C. Allberg, Weare, NH (US)

Correspondence Address: FAY SHARPE LLP, 1100 SUPERIOR AVENUE, SEVENTH FLOOR, CLEVELAND, OH, 44114, US

(73) Assignee: RADQUAL, LLC

(21) Appl. No.: 11/800,330

(22) Filed: May 4, 2007

Related U.S. Application Data
(60) Provisional application No. 60/798,229, filed on May 5, 2006.

(51) Int. Cl. B29C 39/10; B29C 39/26; B29C 39/38; G06Q 10/00; G06Q 30/00

(52) U.S. Cl. 705/1; 264/279; 264/279.1; 264/236; 264/338

(57) ABSTRACT

A method of supplying a made-to-order flood source includes, in response to receiving an order for a flood source from a customer, selecting a mold from a plurality of molds to meet a size of the flood source ordered. A radionuclide is dispersed in a heat curable matrix material to form a mixture. The mixture is cured in the selected mold by application of heat. The cured mixture may be thereafter removed from the mold and encapsulated to form the flood source. The method allows the finished flood source to be shipped to the customer within twenty-four hours of receiving the order.

This application claims the priority of U.S. Provisional Application Ser. No. 60/798,229, filed May 5, 2006, entitled METHOD FOR MANUFACTURING A SOLID UNIFORM FLOOD SOURCE FOR QUALITY CONTROL OF GAMMA IMAGING CAMERAS, the disclosure of which is incorporated herein in its entirety, by reference.

### BACKGROUND

The present exemplary embodiment relates to quality-control testing. It finds particular application in conjunction with the manufacture of flood sources suitable for quality-control testing of gamma cameras, and will be described with particular reference thereto. However, it is to be appreciated that the present exemplary embodiment is also amenable to other like applications.

A gamma camera is an imaging device, commonly used as a medical imaging device in nuclear medicine. It produces images of the distribution of gamma ray emitting radionuclides. It is a complex device consisting of one or more detectors (heads) mounted on a gantry. It is connected to an acquisition system for operating the camera and storing images. The system accumulates counts of gamma photons that are absorbed by a crystal in the cameras detector head, usually a large flat crystal of sodium iodide in a light sealed housing. The crystal scintillates (flash of light) in response to incident gamma radiation when the energy of an absorbed photon is released. This phenomenon is consistent with a photoelectric effect. Photomultiplier tubes (PMT) behind the crystal detect this light (fluorescent) flash and a computer sums the fluorescent counts. The computer using predetermined algorithms constructs and display a two dimensional image of the relative spatial count density. This image reflects the distribution and relative concentration of radioactive tracer elements present in the imaging field of view.

In order to obtain the spatial information about the gamma emissions for an imaging subject, a method of correlating the detected photons with their point of origin is required. The conventional method requires the uses of a collimator placed directly over the crystal/PMT array. The collimator consists of a thick sheet of lead with many thousands of adjacent holes through it. The individual holes limit photons that can be detected by the crystal to a cone. The point of the cone is at the midline center of any given hole and extends to the collimator surface. This collimator is one of the sources of blurring (artifacts) within the image, as it does not totally attenuate incident gamma photons, and thus, permits some “crosstalk” between holes.

To ensure camera performance prior to imaging patients, regular quality-control tests should be performed daily, weekly, and quarterly, as recommended by the Joint Commission on Accreditation of Health Organization and the FDA recommendations developed by physicists of the Center for Devices and Radiological Health. Quality-control tests must be simple, easy to interpret, and require a short period of time to perform. For convenience and safety, unshielded Cobalt-57 sheet sources (flood sources, sheet source, flood phantoms) are regularly used to perform the routine testing. These sheet sources are classified by Regulatory Bodies (FDA) as Medical Devices and are require manufacturing and quality control tests per validated processes.

Current manufacturers of the Cobalt 57 (Co 57) flood sources have responded to the market needs dictated by Camera Manufacturers relative to dimensional and radioactive content requirements for the Co-57 flood sources as well as uniformity specifications required for camera performance by the National Electrical Manufacturers Association (NEMA) document NU 1. Several of these flood source manufacturers use or have used patented processes to meet these demands. However the process most employed by current as well as historical manufacturers entailed the use of an epoxy, urethane, or silicone matrices to ensure product integrity, safety and uniformity requirements. These processes require the mixing of a given radionuclide (predominately Co 57) with the matrix material until uniformity of dispersion or chemical binding is obtained.

This mixture is then poured into a “mold”, which has been leveled or held level by mechanical means. These molds are typically machined from metal (coated with a release compound to allow the removal of the radioactive matrix), thermoformed plastic, or Teflon type material. The mixture is then allowed to cure over a predetermined time period as specified by the epoxy manufacturer. The time period is often 72 hours to 96 hours to ensure the matrix has cured, “setup,” or hardened. Additional time is needed for product quality control to be completed and the product released for distribution.

Often end users of these products require relatively short delivery times, typically within 72 hours but 24 hours is not uncommon. Manufacturers thus try to predict the market demand for various dimensional sizes and activity content for these various sizes. This is accomplished by creating shelf inventory of the more common dimensional and activity content sizes. These inventoried products require additional radionuclide to be added to the process to ensure adequate shelf life, often as much as twenty percent (20%) adding unrecoverable manufacturing costs. If the manufacturer misjudges the market demand, this can result in sales of product at less than the desired or requested activity contents due to the decay of the radioactive isotope, at substantially reduced revenue to cost ratios, or substantial manufacturing cost increases for discarded final product that has decayed to a level that is not saleable.

### BRIEF DESCRIPTION

In one aspect of the invention, a method of providing a flood source includes dispersing a radionuclide in a heat curable matrix material to form a mixture, curing the mixture in a mold by application of heat, and encapsulating the cured mixture to form the flood source.

In another aspect, a method of supplying a made-to-order flood source includes receiving an order for a flood source from a customer, selecting a mold from a plurality of molds to meet a size of the flood source ordered, dispersing a radionuclide in a heat curable matrix material to form a mixture, curing the mixture in the selected mold by application of heat, encapsulating the cured mixture to form the flood source, and shipping the flood source to the customer within twenty four hours of receiving the order.

In another aspect, an on-demand method of supplying flood sources includes providing a plurality of molds of different sizes, receiving an order for a flood source from a customer, selecting a mold from the plurality of molds to meet the customer order, dispersing a radionuclide in a heat curable matrix material to form a mixture, placing the mixture in the mold, curing the mixture in the selected mold by application of heat from a heated plate, cooling the mold, removing the cured mixture from the cooled mold, optionally, encapsulating the cured mixture to form a flood source, and shipping the flood source to the customer within about 5 hours of receiving the order.

### BRIEF DESCRIPTION OF THE DRAWINGS

FIG. 1 is a cross sectional view of a flood source according to one aspect of the exemplary embodiment;

FIG. 2 is a cross sectional view of a flood source according to another aspect of the exemplary embodiment;

FIG. 3 is a side sectional view of the flood source of FIG. 1 or FIG. 2;

FIG. 4 is a schematic view of a system for forming the exemplary flood source which includes a mold according to another aspect of the exemplary embodiment;

FIG. 5 illustrates a cross sectional view of the heating element of FIG. 4; and

FIG. 6 illustrates a method for forming the flood source according to another aspect of the exemplary embodiment.

### DETAILED DESCRIPTION

In various aspects of the exemplary embodiment, a molding process enables the manufacture of a radionuclide-containing product, such as a flood source. The molding process allows the product to be completed, form receipt of order to shipment, in under twenty-four (24) hours and in some embodiments, as little as five (5) hours. This provides a manufacturer of the flood source the ability to take an order from a customer, manufacturer the required product, perform quality control checks on the product, and have it to the customer for use within 24 hours. This eliminates the need to create shelf inventory of perishable products resulting in decreased manufacturing costs, decreased radioactive waste generation, decreased radioactive waste disposal costs, and increased customer satisfaction.

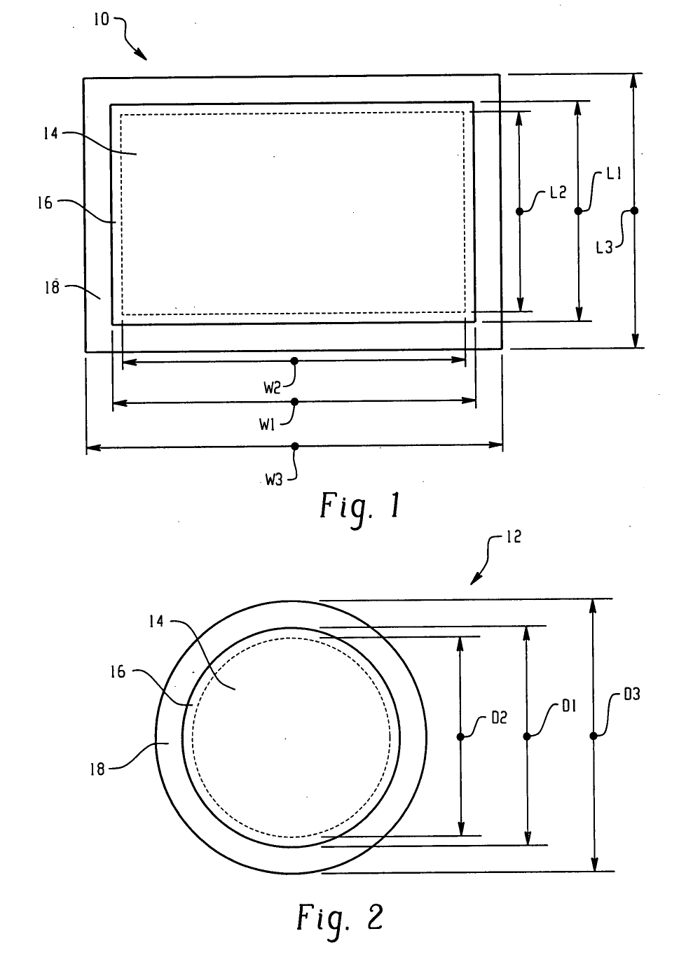

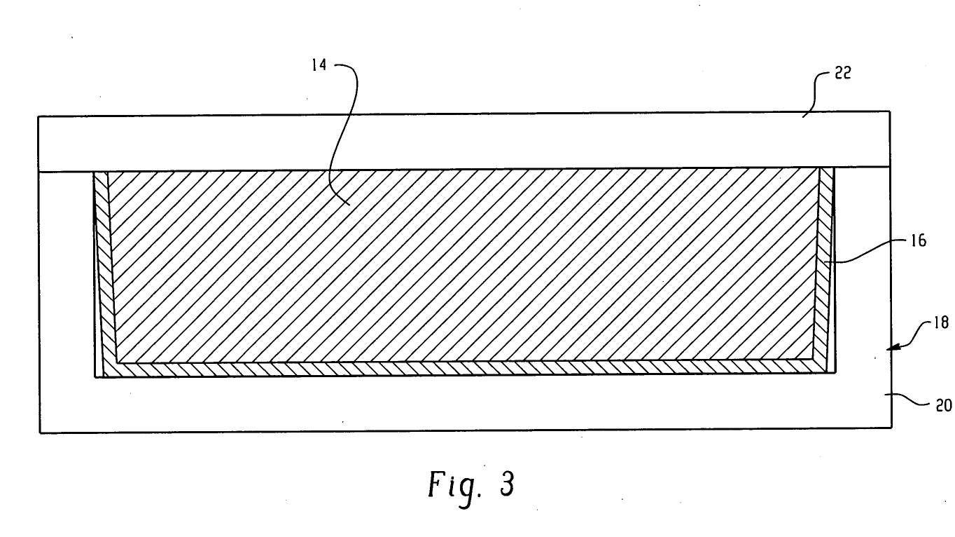

FIG. 1 illustrates an exemplary rectangular flood source 10 and FIG. 2 an exemplary circular flood source 12 which may be formed in the exemplary method. The flood source 10, 12 includes a solidified radioactive mixture 14 comprising a matrix material in which a radionuclide is uniformly dispersed. A release liner 16 surrounds the matrix material. The radioactive mixture 14 and liner 16 are enclosed in an encapsulation container 18 which may be formed in two parts, 20, 22, as illustrated in FIG. 3. The lower part 20 is recessed while the upper part 22 may be in the form of a plate sized to cover the lower part.

The encapsulation container 18 can be made of, for example, acrylonitrile butadiene styrene (ABS), Teflon™, high density polyethylene (HDPE), or other suitable encapsulating material.

Exemplary dimensions for different sizes of the flood source 10, 12, in inches, are given in TABLE 1.

TABLE 1

| Rectangular | L1 | L2 | L3 | W1 | W2 | W3 |
|---|---|---|---|---|---|---|
| 1 | 23.88 | 23.83 | 24.88 | 16.46 | 16.41 | 17.46 |
| 2 | 18.0 | 17.95 | 19.00 | 14.00 | 13.95 | 15.00 |
| 3 | 10.0 | 9.95 | 11.00 | 10.00 | 9.95 | 11.00 |
| 4 | 14.7 | 14.65 | 15.70 | 9.25 | 9.20 | 10.25 |
| 5 | 15.5 | 15.45 | 17.10 | 9.25 | 9.20 | 10.25 |
| Circular | D1 | D2 | D3 | | | |
| 6 | 18.56 | 18.51 | 19.56 | | | |

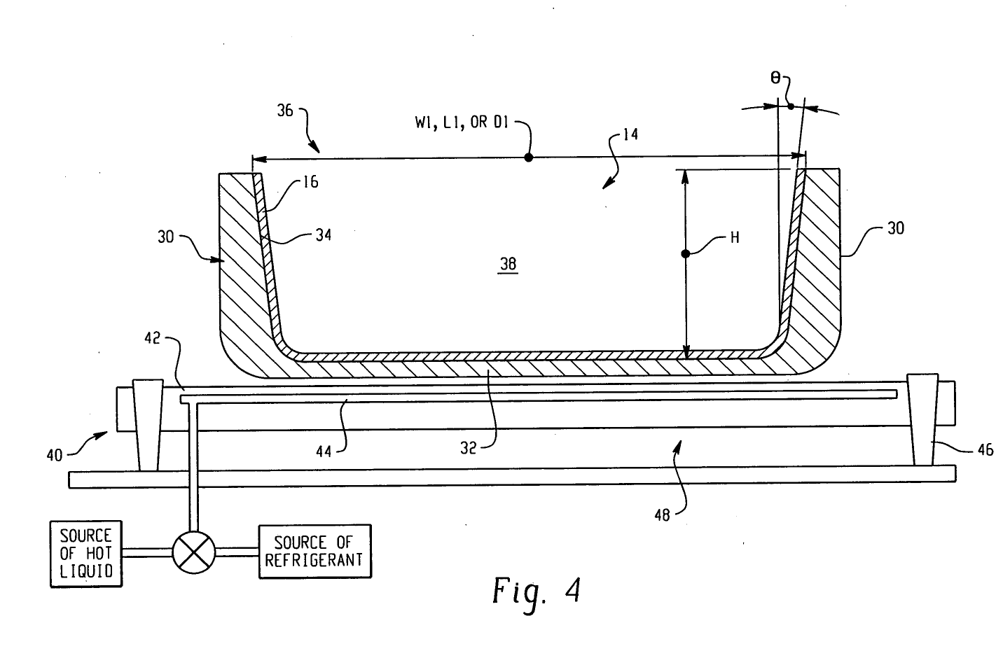

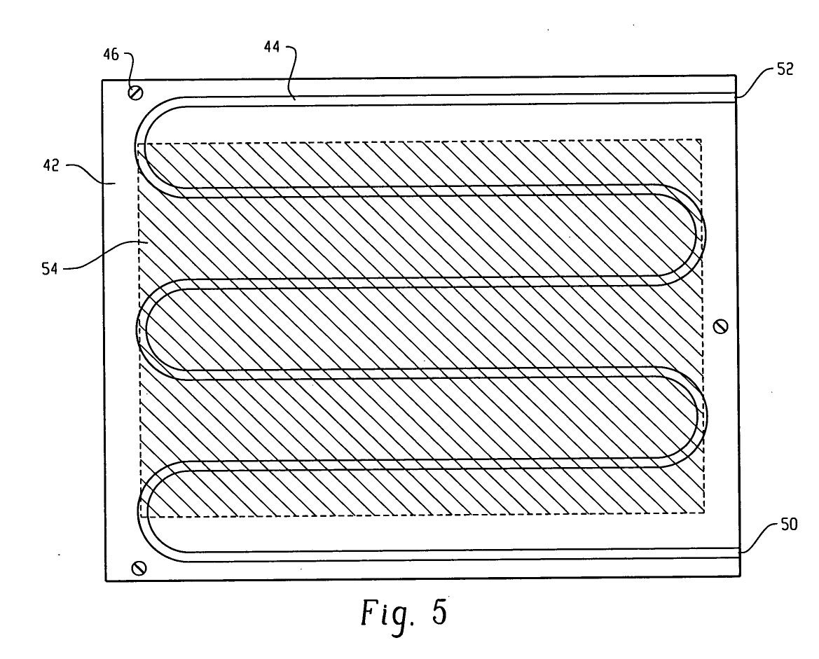

In various aspects, a reusable or disposable casting mold machined from a solid blank, stamped, thermoformed or injection molded to the desired dimensions is used. An exemplary mold 30 is illustrated in FIG. 4. The mold includes a base 32, which can be any desired geometric shape, depending on the desired shape of the flood source, such as rectangular or circular. A wall 34 extends from the base 32 to an upper open end 36 of the mold. The wall 34 may be integrally formed with the base 32 to define an interior recess 38 for receiving the radioactive material 14. The wall has a taper (angle θ) such that a cross sectional area of the mold increases away from the base 32. For example, the wall may decrease in thickness from about 0.50 inches adjacent the base to about 0.45 inches away from the base. Thus, the internal cross-sectional dimensions of the mold increase away from the base by, for example, at least about 0.03 inches and may be up to 0.08 inches (about 0.05 inches in the exemplary embodiment). The height H of the mold can be any suitable height to give the desired thickness of a flood source 10, 12.

In the exemplary method, several molds of different shapes and sizes are provided, such that an appropriate sized mold can be selected to meet a customer's specification.

The mold 30 can be made of, for example, Teflon™, high density polyethylene (HDPE), acrylonitrile butadiene styrene (ABS), aluminum, or similar materials that will not bond directly to the matrix material of choice or to which a liner 16 in the form of a release agent or coating can be applied without negative effect.

With reference to FIG. 4, the release liner 16, where used, may be applied to the mold 30 in the form of a coating, e.g., of a high density polymer, such as a paintable Teflon® coating. Alternatively, the liner may be a rigid or semi rigid material such as polyvinyl chloride or polystyrene (e.g., high impact polystyrene (HIPS)), which supports its own shape and which can be simply placed in the mold 30. The liner 16 may be for example, about 0.05 inches in thickness, or less.

As shown in FIGS. 4 and 5, a heating and cooling assembly 40 is used to cure the flood source 10, 12. The assembly 40 includes a shelf in the form of a planar heating plate 42 which defines a tortuous heating/cooling pathway 44 therethrough. The plate is leveled to maintain a horizontal upper surface with leveling screws 46, which may mount the plate to a supporting surface 48. As shown in FIG. 5, the heating/cooling pathway has an inlet 50 at a first end and an outlet 52 at a second end through which a heating or cooling liquid may enter/leave the pathway 44. The heating area 54 of the plate may be approximately equal to or somewhat larger than the mold 30.

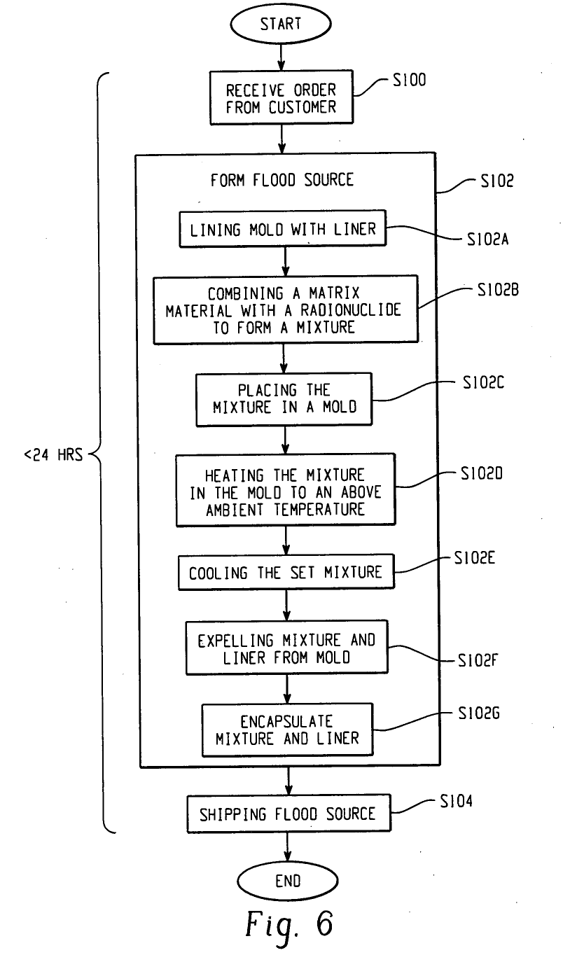

In one aspect of the exemplary embodiment, illustrated in FIG. 6, a method includes receiving an order for a flood source (S100), forming the flood source (S102), and shipping the flood source (S104), within 24 hours of receiving the order.

The forming step may include optionally lining a mold with a liner 16 (S102A), combining a matrix material with a radionuclide to form a mixture (S102B). The mixture is placed in the lined mold (S102C). The mixture in the mold is heating to an above ambient temperature, e.g., at least 40° C., the heating may be performed for a sufficient time to set the mixture (S102D). The method may further include cooling the set mixture (S102E). The cooling may be performed using a cooling liquid which is chilled to below ambient temperature, e.g., to about 15° C. or less. The solidified matrix material thus formed is then expelled from the mold, together with its liner 16 (S102F). The mold 30 may be reused for forming another flood source. At S102G, the solidified radionuclide-containing matrix material 14 and liner 16 are encapsulated to form the finished flood source 10, 12. For example, the combination is paced in the recess of the encapsulant container lower portion 20 and the upper portion 22 sealed to the lower portion, e.g., with heat or with an adhesive bonding material to seal the radioactive material therein. Quality control checks may thereafter be performed on the finished flood source. The product may be shipped such that it is received by the customer within 24 hours. The product may be shipped within as little as 12 hours after receiving the order.

Various steps of the method will now be described in greater detail.

The order (S100) may specify the dimensions of a flood source selected from a predetermined set of flood source dimensions, as determined to the available mold sizes, and a radionuclide at a selected concentration.

The radionuclide-containing matrix material 14 may be formed by combining a matrix material with a selected radionuclide such as Cobalt-57 and casting the mixture in a suitable mold 30. The matrix material can comprise a polymer (such as an epoxy, urethane, silicone, or combination thereof) and optionally a hardener. The polymer may be a thermosetting polymer that exhibits accelerated curing time with the addition of heat. Additionally, the polymer is generally one which demonstrates the ability to uniformly mix or form a chemical complex or bond with the given radionuclide, and is one which allows for the use of inexpensive or disposable casting molds.

For example, a desired radionuclide is added to a one or two part epoxy, silicone or urethane product by either mixing directly with the base material, the accelerator material (hardener), or mixed base and accelerator material to uniformly disperse the radionuclide throughout the matrix material. Uniformity of dispersion or bonding can be measured prior to casting the material. This can be done efficiently by “assaying” or measuring the radionuclide content in multiple gravimetric samples or by adding an appropriate colored dye and measuring a sample in a calorimeter.

The mold 30 is placed onto a shelf 42 or similar flat surface that has an area large enough to support the desired mold dimensions (e.g., 30 inches by 24 inches). The mold 30, or the shelf 42 supporting the mold, is leveled to greater than 0.005 inches over the entire surface. While in the illustrated embodiment of FIG. 4, the shelf 42 has a self-contained heating system, in other embodiments, the heating system may be incorporated into the mold 30 itself. In other embodiments, the mold 30 may be placed into a cabinet or “curing oven” where the ambient air temperature can be raised to the appropriate temperature to promote rapid curing of the matrix as defined by the product manufacturer or determined through experimentation. Once curing has been achieved, the mold and matrix are cooled to room temperature and the matrix removed. Placing the mold on or in an environment where the temperature is sufficiently low enough to expedite cooling of the mold and matrix can accelerate the cooling. For example, a heating/cooling pump 50 recirculates a heating/cooling liquid from a respective source 52, 54 through the mold, shelf, or oven. The liquid can be water or organic liquid. The heating/cooling liquid may be supplied through tubing passing though the shelf, mold, or oven. For setting the polymer, the liquid is heated. The liquid is then chilled to cool the mold, shelf, or oven. The time taken for setting the polymer is generally less than 5 hours, e.g., two hours, and it is generally cool enough to remove from the mold within one or two hours after the heating is stopped.

The formed flood source may be shipped by overnight mail or other suitable guaranteed next day delivery service.

Exemplary radionuclides include Cobalt-57 (Co-57), Gold-195 (Au-195), and Germanium-68 (Ge-68). However, the method are applicable to any radionuclide the exhibits the ability to disperse uniformly or chemically bond with epoxy, urethane, silicone or similar matrix material.

In one embodiment, the radionuclide is at a concentration which is at the concentration requested by the customer, such as 10-20 millicurie. There is no need to add extra radioactive material, beyond the client's specified amount, as the product is made to order and shipped within 24 hours. The method allows the customer to receive any desired radionuclide concentration that is capable of being formulated.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method of providing a flood source comprising:
dispersing a radionuclide in a heat curable matrix material to form a mixture;
curing the mixture in a mold by application of heat; and
encapsulating the cured mixture to form the flood source.

2. The method of claim 1, wherein curing includes heating the mixture in the mold to a temperature of at least 40° C.

3. The method of claim 1, wherein the curing includes curing the mixture in less than 5 hours.

4. The method of claim 1, wherein the heating includes heating the mold on a heated plate which carries a heating liquid.

5. The method of claim 1, further comprising, before encapsulating, cooling the cured mixture.

6. The method of claim 5, wherein the cooling includes cooling the mold on a cooled plate which carries a cooling liquid.

7. The method of claim 1, further comprising lining the mold with a release liner.

8. The method of claim 7, wherein the release liner is formed of extruded polystyrene.

9. The method of claim 7, wherein the encapsulating includes encapsulating the cured mixture and release liner.

10. The method of claim 1, further comprising selecting a mold from a plurality of molds of different sizes.

11. The method of claim 1, further comprising, forming the mixture in response to receiving a customer order for the flood source and shipping the flood source within twenty four hours of receiving the order.

12. A method of supplying a made-to-order flood source comprising:
receiving an order for a flood source from a customer;
selecting a mold from a plurality of molds to meet a size of the flood source ordered;
dispersing a radionuclide in a heat curable matrix material to form a mixture;
curing the mixture in the selected mold by application of heat;
encapsulating the cured mixture to form the flood source; and
shipping the flood source to the customer within twenty four hours of receiving the order.

13. The method of claim 12, wherein curing includes heating the mixture in the mold to a temperature of at least 40° C.

14. The method of claim 12, wherein the curing includes curing the mixture in under 5 hours.

15. The method of claim 12, wherein the heating includes heating the mold on a heated plate which carries a heating liquid.

16. The method of claim 12, further comprising, before encapsulating, cooling the cured mixture.

17. The method of claim 16, wherein the cooling includes cooling the mold on a cooled plate which carries a cooling liquid.

18. The method of claim 12, further comprising lining the mold with a release liner.

19. The method of claim 18, wherein the release liner is formed of polyethylene or polystyrene.

20. The method of claim 18, wherein the encapsulating includes encapsulating the cured mixture and release liner.

21. The method of claim 12, wherein the shipping the flood source to the customer enables the customer to receive the flood source within twenty fours hours of the order being placed.

22. An on-demand method of supplying flood sources:
providing a plurality of molds of different sizes;
receiving an order for a flood source from a customer;
selecting a mold from the plurality of molds to meet the customer order;
dispersing a radionuclide in a heat curable matrix material to form a mixture;
placing the mixture in the mold;
curing the mixture in the selected mold by application of heat from a heated plate;
cooling the mold;
removing the cured mixture from the cooled mold;
optionally, encapsulating the cured mixture to form a flood source;
shipping the flood source to the customer within about 5 hours of receiving the order.
